(19) United States
(12) Patent Application Publication
(10) Pub. No.: US 2019/0143548 A1
(43) Pub. Date: May 16, 2019

(54) CUTTING DEVICE

(71) Applicant: Hong-Soon Park, Gyeonggi-do (KR)

(72) Inventor: Hong-Soon Park, Gyeonggi-do (KR)

(21) Appl. No.: 16/188,450

(22) Filed: Nov. 13, 2018

(30) Foreign Application Priority Data
Nov. 13, 2017 (KR) 10-2017-0150718

(51) Int. Cl. B26D 1/06; B26D 5/08

(52) U.S. Cl. CPC B26D 1/06; B26D 5/08

(57) ABSTRACT

Provided is a cutting device. The cutting device includes a body part having a transfer path along which a cut object being transferred is transferred, a cutting part including cutting elements for cutting the cut object and a main body on which the cutting elements are disposed, and a pressing part configured to press the main body so that the cutting elements move in a cutting direction that is a direction crossing the transfer direction of the cut object. The body part further includes a guide path having a shape corresponding to that of the cutting part so as to provide a space along which the cutting part moves in the cutting direction and a return direction that is opposite to the cutting direction.

### CROSS-REFERENCE TO RELATED APPLICATIONS

This application claims the priority of Korean Patent Application No. 10-2017-0150718, filed on Nov. 13, 2017, in the Korean Intellectual Property Office, the disclosure of which is incorporated herein by reference.

### BACKGROUND OF THE INVENTION

### Field of the Invention

The present invention relates to a cutting device.

### Description of the Related Art

FIG. 1 is a perspective view of a cutting device according to an embodiment of the present invention. As illustrated is FIG. 1, a cutting device is used to cut a portion of an object 10 to be cut (hereinafter, referred to as a cut object). According to the related art, when a blade used for cutting the cut object 10 is worn, the worn blade has to be replaced with a new blade. Thus, a number of blades may be consumed. Also, since it is necessary to provide a different cutting device according to a shape and position of an object to be cut, the replacement of the cutting device is very cumbersome, and the cutting is taken for a long time.

### SUMMARY OF THE INVENTION

An aspect of the present invention provides a cutting device that is capable of being efficiently utilized without replacing a blade for cutting.

Another aspect of the present invention provides a simple cutting device which does not need to be replaced with a new blade according to a shape and position of an object to be cut.

According to an aspect of the present invention, there is provided a cutting device including: a body part having a transfer path along which a cut object being transferred is transferred; a cutting part including cutting elements for cutting the cut object and a main body on which the cutting elements are disposed; and a pressing part configured to press the main body so that the cutting elements move in a cutting direction that is a direction crossing the transfer direction of the cut object, wherein the body part further comprises a guide path having a shape corresponding to that of the cutting part so as to provide a space along which the cutting part moves in the cutting direction and a return direction that is opposite to the cutting direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a cutting device according to an embodiment of the present invention;

FIG. 2 is an exploded perspective view of the cutting device according to an embodiment of the present invention;

FIG. 3 is a perspective view of a separable block;

FIG. 4 is a side view of the separable block;

FIG. 5 is a perspective view of a cutting part having a column shape;

FIG. 6 is a perspective view of a cutting part having a right rectangular prism shape;

FIG. 7 is an enlarged front view of an area A of FIG. 2;

FIG. 8 is a front view of a cutting device according to a modified example of the present invention; and

FIG. 9 is a perspective view illustrating the cutting device according to the modified example of the present invention.

### DETAILED DESCRIPTION OF THE PREFERRED EMBODIMENT

Hereinafter, embodiments of the present invention will be described in detail with reference to the accompanying drawings. It is noted that the same or similar components in the drawings are designated by the same reference numerals as far as possible even if they are shown in different drawings. In the following description of the present invention, a detailed description of known functions and configurations incorporated herein will be omitted to avoid making the subject matter of the present invention unclear.

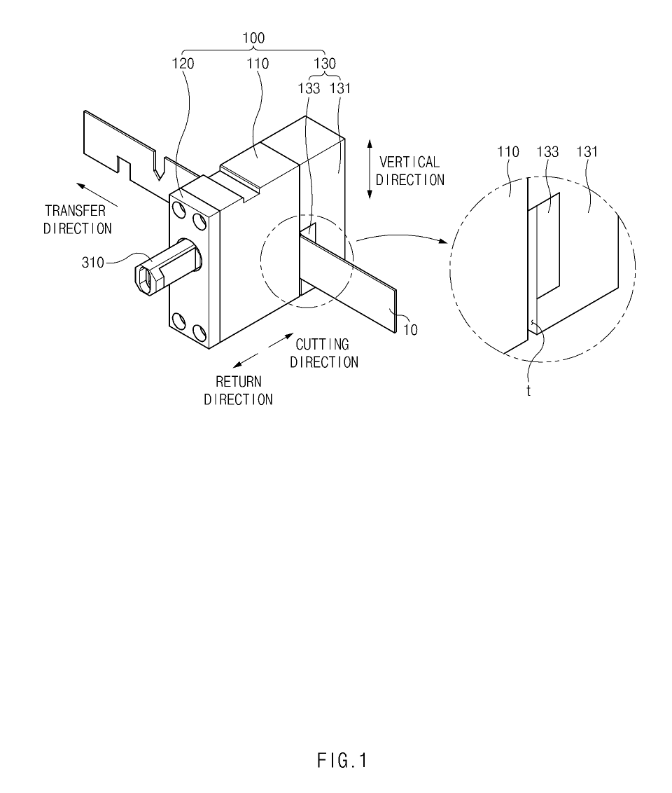

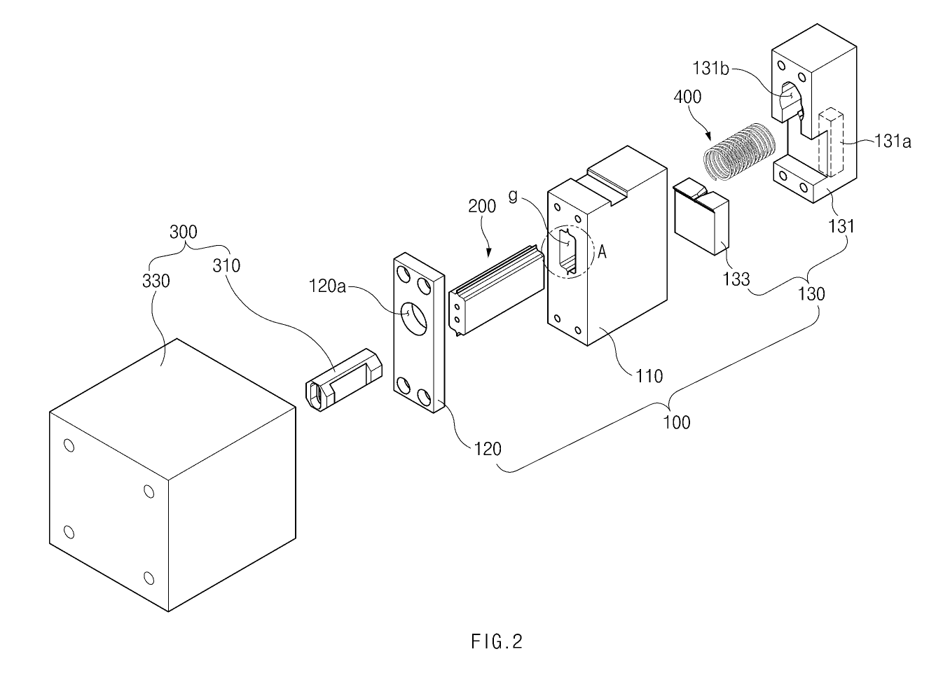

FIG. 1 is a perspective view of a cutting device according to an embodiment of the present invention. FIG. 2 is an exploded perspective view of the cutting device according to an embodiment of the present invention. Hereinafter, a cutting device according to an embodiment of the present invention will be described with reference to FIGS. 1 and 2.

A cutting device according to an embodiment of the present invention includes a body part 100, a cutting part 200, and a pressing part 300. While a cut object is transferred, the cut object passes through a transfer path provided in the body part 100. While the cut object passes through the transfer path, the cutting part 200 cuts the cut object. Also, the pressing part 300 may press the cutting part 200 toward the cut object so that the cutting is performed. Each of the constituents will be described below in more detail.

Body Part

Referring to FIG. 2, the body part 100 may include a first body 110, a second body 120, and a third body 130. The first body 110, the second body 120, and the third body 130 may be separably coupled to each other. The coupling manner of the first body 110, the second body 120, and the third body 130 is not specifically limited thereto. For example, the first body 110, the second body 120, and the third body 130 may be coupled to each other through screw coupling.

As described above, a transfer path t is provided in the body part 100 so that the cut object 10 that is being transferred is transferable. As illustrated in FIG. 1, the transfer path t may be disposed between the first body 110 and the third body 130, and the cut object 10 may pass through the transfer path t while the cut object 10 is transferred in a transfer direction.

The cut object 10 may be a plate having a band shape as illustrated in FIG. 1. For example, the cut object 10 may be a cutting blade having a thickness in a cutting direction and a height in a vertical direction that is perpendicular to the transfer direction and the cutting direction. Here, as illustrated in the enlarged view of FIG. 1 (the cut object is not limited for convenience of description), the transfer path t may have an opened one sided so that all the cut objects 10 having heights different from each other are transferred along the transfer path t.

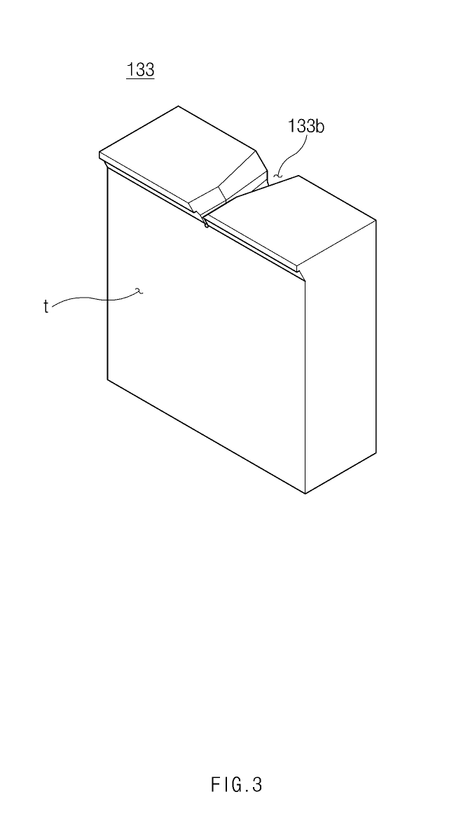

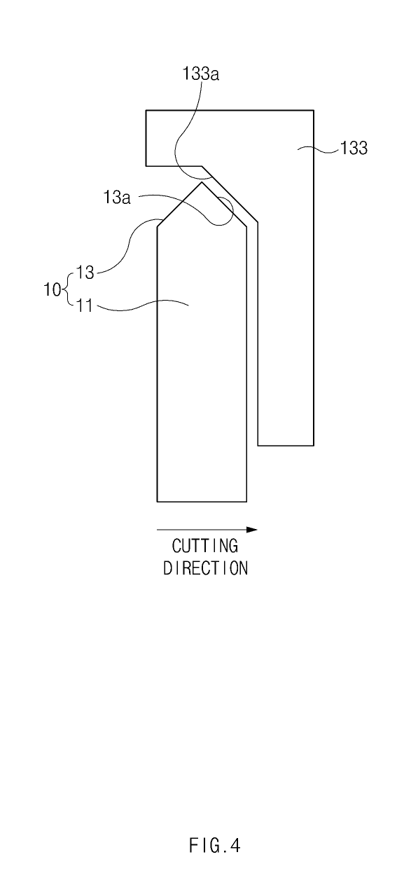

FIG. 3 is a perspective view of a separable block. FIG. 4 is a side view of the separable block. Hereinafter, the transfer path will be described with reference to FIGS. 1 to 3.

As illustrated in FIG. 2, the third body 130 may include a separable block 133, and a fixed block to which the separable block 133 is separably coupled. As illustrated in the enlarged view of FIG. 1, a space between the first body 110 and the fixed block 131 and a space between the first body 110 and the separable block 133 may form the transfer path t together with each other.

As described above, one side of the transfer path may be opened, and thus, the cut object 10 having a height greater than that of the transfer path t may pass through the opened one side as illustrated in FIG. 4.

Also, the cutting blade may be provided with a plate-shaped plate 11 having a thickness corresponding to the cutting direction and a blade 13 formed with a gradually thinner plate 11. When the cut object 10 is pressed in the cutting direction, the blade may not be engaged with an inner surface of the separable block 133, and thus, the cut object 10 may be changed in position.

Thus, an inner surface of the entire inner surface of the separable block 133, which face the cut object 10 may be formed in a shape corresponding to a shape of an outer surface facing the cutting direction of the blade 13. For example, an inclined surface 13a of the blade 13, which is disposed on the outer surface facing the cutting direction of the blade and an inclined surface 133a of the block, which is disposed on the inner surface of the separable block 133 facing the cut object 10, may have shapes corresponding to each other.

Thus, when the cutting is performed while the cut object 10 is pressed in the cutting direction, the cut object 10 may not be changed in position while the blade inclined face 13a and the block inclined face 133a are engaged with each other, and thus, the cutting may be stably performed.

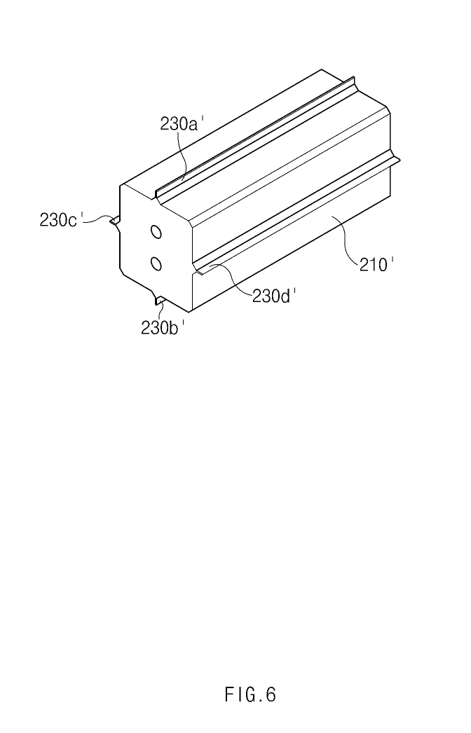

Also, a groove providing a space through which the cutting part 200 that cuts the cut object 10 passes through the cut object 10 to move may be formed in the separable block 133 and the fixed block 131. More particularly, a guide groove 133b providing a space through which cutting elements (see reference numerals 230a and 230b of FIG. 6) that will be described later pass through the cut object 10 to move may be formed in the separable block 133 (see FIG. 3). Also, an accommodation groove 131b providing a space through which the cutting part 200 passes through the cut object 10 to move may be formed in the fixed block 131 (see FIG. 2).

Also, a discharge path 131a through which fragments of the cut object 10 cut by the cutting part 200 are discharged may be provided in the fixed block 131. The discharge path 131a may be opened from in the vicinity of the accommodation groove 131b within the fixed block 131 toward the outside. The discharge path 131a may pass through the fixed block 131. Thus, the fragments of the cut object 10 cut by the cutting part 200 may move together with the cutting part 200 up to the accommodation groove 131b and then be discharged to the outside through the discharge path 131a.

Here, an air injection nozzle (not shown) for assisting the discharge of the fragments may be provided in the discharge path 131a. The air injection nozzle may inject air to discharge the fragments to the outside while allowing the cutting part 200 to be maintained in the state of being pressed in the cutting direction, thereby preventing the fragments from being introduced into the first body 110.

Cutting Part

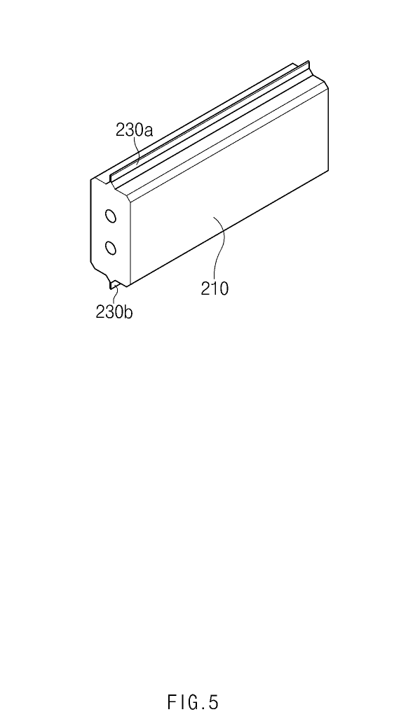

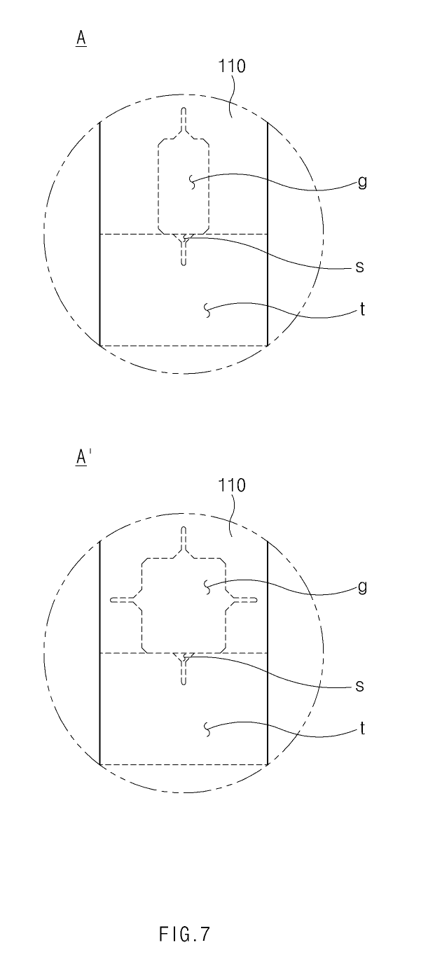

FIG. 5 is a perspective view of a cutting part having a column shape. FIG. 6 is a perspective view of a cutting part having a right rectangular prism shape. FIG. 7 is an enlarged front view of an area A of FIG. 2; Hereinafter, the cutting part according to the present invention will be described in more detail with reference to FIGS. 5 to 7.

As illustrated in FIG. 2, the cutting part 200 cuts the cut object 10 while moving in the cutting direction that is a direction crossing the transfer direction of the cut object 10. Also, the body part 100 further includes a guide path g having a shape corresponding to that of the cutting part 200. That is, the guide path g provides a space through which the cutting part 200 moves in the cutting direction and a return direction that is opposite to the cutting direction.

The guide path g may pass through the first body 110. Also, the second body 120 may be separably coupled to the first body 110 with the cutting part 200 therebetween to prevent the cutting part 200 inserted into the guide path g from being separated from the guide path g. That is to say, the cutting part 20 may be movable in the cutting direction and the return direction along the guide path g in the state of being accommodated between the first body 110 and the second body 120.

As illustrated in FIGS. 5 and 6, the cutting part 200 may include cutting elements 230a and 230b for cutting the cut object 10 and main body 210 provided with the cutting elements 230a and 230b.

The main body 210 may have a column shape having a plurality of side surfaces. Also, the cutting elements 230a and 230b may be disposed on at least two side surfaces of the main body 210. Also, when the cutting part 20 moves in the cutting direction, the cutting elements 230a and 230b disposed on one side surface of the side surfaces of the main body 210 may cut the cut object 10.

FIG. 7A illustrates a region in which the guide path g having a shape corresponding to that of the cutting part of FIG. 5 is provided, and FIG. 7A′ illustrates a region in which the guide path g having a shape corresponding to that of the cutting part of FIG. 6 is provided. As illustrated in FIG. 7, the cutting elements 230a and 230b may be individually inserted into the cutting area s. Alternatively, one of the cutting elements 230a and 230b may be selectively inserted into the cutting area s. Here, the cutting area s may represents an area of the guide path g, which is disposed to cross the transfer path t and into which the cutting elements 230a and 230b, which participate in the cutting of the cut object 10, are inserted.

That is, in FIG. 5, the first cutting element 230a and the second cutting element 230b are provided in the main body 210. Here, all of the first cutting element 230a and the second cutting element 230b may be inserted into the cutting area s. Also, only one of the first cutting element 230a and the second cutting element 230b may be selectively inserted into the cutting area to participate in the cutting.

Thus, while the cutting of the cut object 10 is performed by using the first cutting element 230a, If the first cutting element 230a is worn out, and thus further cutting is not possible, when the cutting part is inserted into the guide path g so that the second cutting element 230b is inserted into the cutting area s, it may be efficient because one cutting part 200 is used twice.

Also, at least one of the cutting elements 230a and 230b may extend from one side to the other side of the side surfaces of the main body 210 in the cutting direction. Alternatively, at least one of the cutting elements 230a and 230b may be formed symmetrically on one side and other side in the cutting direction.

When the cutting elements 230a and 230b cut the cut object 10, the substantially used portion may be one end or the other end of the cutting element 230a and 230b. Thus, when the cutting elements 230a and 230b extend from one side to the other, or both sides are symmetrical to each other without extending, one cutting element 230a or 230b may be used twice by injecting one side of the cutting part 200 forward into the guide path g or by inserting the other side of the cutting part 200 forward into the guide path g. This is possible because the main body 210 are symmetrically formed in the column shape along the cutting direction.

That is to say, the first cutting element 230a is inserted into the cutting area s so that one side of the cutting part 200 is inserted forward into the guide path g to perform the cutting. Then, if the one side of the first cutting element 230a is worn out, the first cutting element 230a is inserted into the cutting area s so that the other side of the first cutting element 230a is inserted forward into the guide path g. As a result, the first cutting element 230a may be utilized again.

Furthermore, when the first cutting element 230a is worn out, one side of the second cutting element 230b is inserted forward into the cutting area s. Then, when the other side of the second cutting element 230b is inserted forward again into the cutting area s, one second cutting element 230b may be utilized twice. That is, the cutting part 200 may be utilized twice through one cutting part 200 by the number of side surfaces on which the cutting elements 230a and 230b are disposed. In the case of the cutting part 200 illustrated in FIG. 5, one cutting part 200 may be utilized four times.

As illustrated in FIG. 6, when the main body 210′; has a square column shape, a cutting part 200′ may be inserted into the guide path s with all four sides facing the cutting area s. Thus, when the cutting elements 230a′, 230b′, 230c′, and 230d′ are provided on all four sides, one cutting part 200′ may be utilized eight times, which is very efficient.

Pressing Part

Hereinafter, the pressing part will be described with reference to FIGS. 1 and 2. The pressing part 300 presses the main body 210 of the cutting part 200 so that the cutting elements move in the cutting direction. Particularly, the pressing part 300 may include a pressing member 310 and a driving unit 330.

The pressing member 310 represents a member for directly pressing the main body 210. The pressing member 310 may pass through a pressing groove 120a defined in the second body 120 to press the main body 210. The pressing member 310 is not particularly limited in shape.

The driving unit 330 presses the pressing member in the cutting direction to allow the pressing member 310 to press the main body 210. The driving unit 330 is also not particularly limited in operation manner, and for example, a cylinder may be used.

The cutting device according to an embodiment of the present invention may further include an elastic member 400. The elastic member 400 may press the cutting part 200, which moves in the cutting direction by the pressing part 300, in a return direction to allow the cutting part 200 to return to its original position.

More particularly, when the pressing of the pressing member 310 toward the main body 210 due to the operation of the driving unit 330 and the cutting of the cut object 10 by the cutting unit 200 are completed, the elastic member 400 may press the main body 210, which moves in the cutting direction, in the return direction to allow the main body 210 to return to its original position.

Here, the elastic member 400 may be accommodated in the accommodation groove 131b to always press the main body 210 in the return direction. That is, the first body 210 and the second body 220 are coupled to each other with the elastic member 400 therebetween to prevent the elastic member 400 from being separated from the accommodation groove 131b.

Operation Process of Cutting Device

Hereinafter, an operation process of the cutting device according to an embodiment of the present invention will be described with reference to FIGS. 1 to 7.

First, the cut object 10 being cut is disposed in a body part 100 to pass through the transfer path t provided in the body part 100. The body part 100 may be previously installed in a transfer path of the cut object 10.

The driving unit 330 may be set to press the pressing member 310 when a portion to be cut of the cut object 10 passes through the cutting area s. When the driving unit 330 presses the pressing unit 310 in the cutting direction, the pressing member 310 presses the main body 210 of the cutting part 200 to allow one of the cutting elements 230a and 230b to cut the cut object 10 while passing through the cutting area s.

When the cutting of the cut object 10 by the cutting part 200 is completed, cut fragments may be discharged through the discharge path 131a, and the cutting part 200 may return to its original position by elastic force of the elastic member 400 in the return direction. This cutting process may be repeatedly performed.

When the cutting elements 230a and 230b, which participate in the cutting during the cutting operation, are worn out, a worker may stop the cutting operation. The worker may separate only the first body 110 and the second body 120 to change the insertion direction of the cutting part 200 so that the cutting elements 230a and 230b passing through the cutting area s are changed.

As illustrated in FIG. 6, if the cutting part which has the main body 210′ of the square column shape and on which the cutting elements 230a′, 230b′, 230c′, and 230d′ are disposed on four side surfaces thereof is being used, the cutting part may be inserted into the guide path g so that one side and the other side of each of the first to fourth cutting elements 230a′ to 230d′ may be inserted forward. When the insertion of the cutting part is complete, the worker may assemble the first body 110 and the second body 120 again to immediately perform a new cutting operation.

### Modified Example

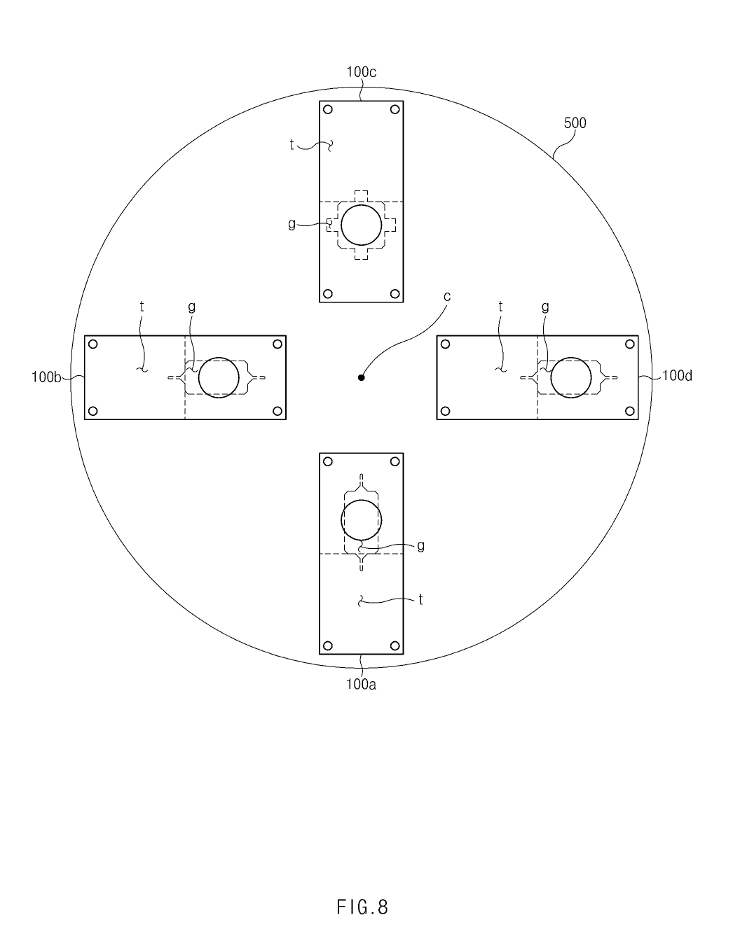

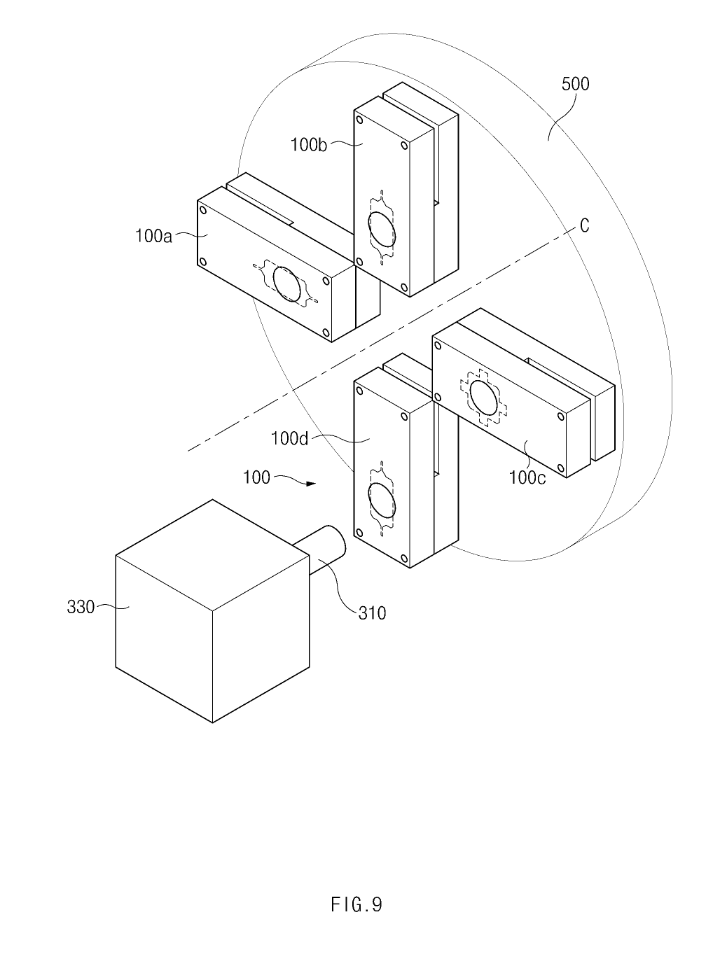

FIG. 8 is a front view of a cutting device according to a modified example of the present invention; and FIG. 9 is a perspective view illustrating the cutting device according to the modified example of the present invention. Hereinafter, a cutting device according to a modified example of the present invention will be described with reference to FIGS. 8 and 9.

A cutting device according to a modified example of the present invention may further include a base part 500. The base part 500 is configured to rotate around a rotation axis c formed along a direction parallel to the cutting direction, and a plurality of body parts 100a to 100d may be coupled to the base part 500. Here, the plurality of body parts 100a to 100d may be provided with guide paths g having different shapes or guide paths g disposed at different positions.

When the cut object 10 is cut, it is necessary to provide guide paths (or cutting parts) having different shapes and guide paths disposed at different positions according to position to be cut or a shape to be formed by cutting. However, the guide path that is capable of being provided in one body part may be limited in shape and position.

However, the cutting device according to the modified example of the present invention may further the base part 500. A plurality of body parts 100a to 100d having guide paths g having different shapes or guide paths g disposed at different positions may be coupled to the base part 500. Thus, the cut object 10 may be cut into a desired shape at a desired position through the rotation of the base part 500 without replacing the body parts.

More particularly, the base part 500 may rotate so that one of the plurality of body parts 100a to 100d is disposed in the transport path of the cut object 10. When the body part having the desired guide path g is disposed in the transfer path of the cut object 10, the pressing part 300 may operate so that the cut object 10 is cut.

Also, at least one of the base part 500 and the pressing part 300 may be displaced so that the guide path g provided in the body part 100 disposed in the transport path of the cut object 10 and the pressing part 300 are disposed at positions corresponding to each other. For example, as illustrated in FIG. 9, when the body part 100d having the guide path g provided below the transfer path t is disposed in the transfer path so as to cut a lower portion of the cut object 10, positions of the guide path g and the pressing member 310 in a vertical direction may not correspond to each other. Here, at least one of the pressing part 300 and the base part 500 is provided to be vertically displaceable and thereby to allow the pressing member 310 to accurately press the main body (see reference numeral 210 of FIG. 5) disposed in the guide path g.

As described above, since the cutting device according to the modified example of the present invention includes the base part 500, the cut object may be cut into a desired shape at a desired position without the necessity of installing a new cutting device again in the transfer path of the cut object 10.

According to the present invention, the one cutting part may be utilized several times by changing the use direction of the cutting part so that the cut object is cut very economically.

Also, according to the present invention, the base part may rotate locate the body part provided with the guide path having the desired shape at the desired position. Thus, the cut object may be very simply cut in the desired shape at the desired position.

The above-disclosed subject matter is to be considered illustrative, and not restrictive, and the appended claims are intended to cover all such modifications, enhancements, and other embodiments, which fall within the true spirit and scope of the present disclosure. Thus, the embodiment of the present invention is to be considered illustrative, and not restrictive, and the technical spirit of the present invention is not limited to the foregoing embodiment. Therefore, the scope of the present disclosure is defined not by the detailed description of the invention but by the appended claims, and all differences within the scope will be construed as being included in the present disclosure.

What is claimed is:

1. A cutting device comprising:
a body part having a transfer path along which a cut object being transferred is transferred;
a cutting part comprising cutting elements for cutting the cut object and a main body on which the cutting elements are disposed; and
a pressing part configured to press the main body so that the cutting elements move in a cutting direction that is a direction crossing the transfer direction of the cut object,
wherein the body part further comprises a guide path having a shape corresponding to that of the cutting part so as to provide a space along which the cutting part moves in the cutting direction and a return direction that is opposite to the cutting direction.

2. The cutting device of claim 1, wherein the main body has a column shape with a plurality of side surfaces,
the cutting elements are disposed on at least two side surfaces of the main body, and
the cutting part moves in the cutting direction to allow the cutting element disposed on one of the side surfaces to cut the cut object.

3. The cutting device of claim 2, wherein the cutting elements are individually insertable into a cutting area that is an area of an area of the guide path, which is provided to cross the transfer path and into which the cutting element participating in the cutting of the cut object is inserted,
wherein one of the cutting elements is selectively inserted into the cutting area.

4. The cutting device of claim 2, wherein at least one of the cutting elements extends from one side to the other side of the side surface in the cutting direction.

5. The cutting device of claim 2, wherein at least one of the cutting elements is provided symmetrically on one side and other side in the cutting direction, and
the cutting part is selectively configured so that the one side of the cutting element is inserted forward into the guide path, or the other side of the cutting element is inserted forward into the guide path.

6. The cutting device of claim 1, further comprising an elastic member pressing the main body, which moves in the cutting direction, in the return direction to allow the main body to return to its original position when the pressing of the pressing part toward the main body and the cutting of the cut object are completed.

7. The cutting device of claim 1, wherein the body part comprises:
a first body through which the guide path passes; and
a second body separably coupled to the first body with the cutting part therebetween to prevent the cutting part inserted into the guide path from being separated from the guide path.

8. The cutting device of claim 1, wherein the transfer path has opened one side to transfer the cut objects having sizes different from each other.

9. The cutting device of claim 1, further comprising a base part rotating around a rotation axis defined along a direction parallel to the cutting direction,
wherein a plurality of body parts having guide paths having different shapes or disposed at different positions are coupled to the base part, and
the base part rotates so that one of the plurality of body parts is disposed in the transfer path of the cut object.

10. The cutting device of claim 9, wherein the transfer path has opened one side so that the cut objects having sizes different from each other pass through the opened one side.

11. The cutting device of claim 9, wherein at least one of the base part and the pressing part is displaced so that the guide path provided in the body part disposed in the transport path of the cut object and the pressing part are disposed at positions corresponding to each other.
